(19) United States
(12) Patent Application Publication
(10) Pub. No.: US 2019/0008148 A1
(43) Pub. Date: Jan. 10, 2019

(54) Pet Drinking Deterrent

(71) Applicant: Kenneth George Kusterer, Tampa, FL (US)

(72) Inventor: Kenneth George Kusterer, Tampa, FL (US)

(21) Appl. No.: 15/643,516

(22) Filed: Jul. 7, 2017

(51) Int. Cl. A01N 37/44; A01M 29/00

(52) U.S. Cl. CPC A01N 37/44; A01M 29/00

(57) ABSTRACT

A pet deterrent includes a dispensing system containing a bitterant such as denatonium benzoate. The dispensing system is interfaced to a toilet, thereby delivering a portion of the bitterant to water within the toilet. This makes drinking of the water by a pet unpleasant. One such dispensing system is a slow release tablet containing the bitterant (e.g. denatonium benzoate). The slow release tablet is positioned within a toilet and interfaced to water within the toilet, thereby releasing a portion of the bitterant to water within the toilet.

### FIELD

This invention relates to the field of pets/animals and more particularly to a system for thwarting drinking of water from a toilet by a pet.

### BACKGROUND

Many pets, in particular canines, take part in drinking water from a toilet or urinal. Such pets find drinking from a toilet to be refreshing and enjoyable, possible because the water is fresh as the toilet is flushed often during the day, and cool, as the toilet holds more water in a typically stone/porcelain bowl that has better heat retention capabilities than a pet dish that may be situated in the sun.

Toilets often harbor microbes/germs that can infect the pet and make the pet ill. Although many pets are not affected by some microbes, unfortunately, the very same microbes that don't affect pets will often affect humans. Unfortunately, these same pets that drink from toilets often come into contact with humans, in particular, young humans. Some such pets enjoy licking humans or the pet eats from dishware that is later used by humans. There exists a possibility of contamination from the pet to a human, potentially leading to disease of the human.

Notwithstanding the thought of being licked by a pet that has just had a drink from a toilet is unpleasant for many humans.

What is needed is a system that will make it undesirable for a pet to drink from a toilet bowl.

### SUMMARY

In one embodiment, a pet deterrent is disclosed including a dispensing system containing a bitterant. The dispensing system is interfaced to a toilet, thereby delivering a portion of the bitterant to water within the toilet. This makes drinking of the water by a pet unpleasant.

In another embodiment, a pet deterrent is disclosed including a slow release tablet containing a bitterant. The slow release tablet is positioned within a toilet and interfaced to water within the toilet, thereby releasing a portion of the bitterant to water within the toilet. This makes drinking of the water undesirable by a pet that has access to the water within the toilet.

In another embodiment, a pet deterrent is disclosed including a slow release tablet for positioning within a toilet. The slow release tablet is interfaced to water within the toilet, thereby releasing a portion of the bitterant to water within the toilet. This makes drinking of the water undesirable by a pet that has access to the water within the toilet. The slow release tablet includes from 10-90% of a binder; from 10-90% of a stabilizer; from 0-10% of water; from 0.05% to 5% of the bitterant; and from 0.1% to 16% of a second stabilizer.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a pet ready to drink from a toilet bowl.

FIG. 2 illustrates a perspective view of the toilet bowl equipped with a pet deterrent.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

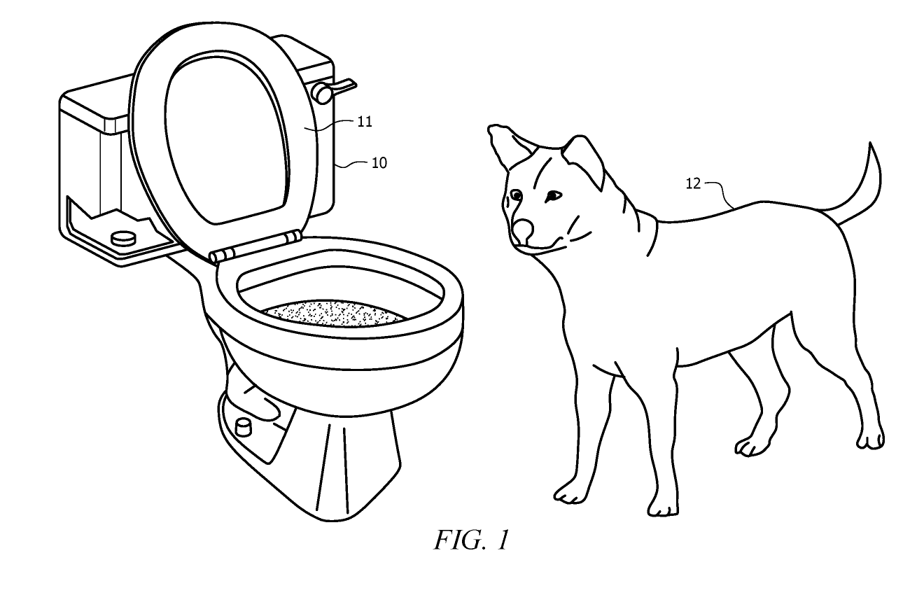

Referring to FIG. 1, a perspective view of a pet 12 ready to drink from a toilet 10 is shown. As the lid 11 to the toilet 10 has been left open, the pet 12 has access to drink water from the toilet 10. Pets 12 often find it fulfilling to drink from a toilet 10, as the water in the toilet 10 is often fresh (recent flush) and cool. Unfortunately, drinking water from a toilet 10 introduces microbes into the pet's 12 mouth and, upon contact with humans, some of those microbes are transferred to the humans with the potential to cause illness in the humans.

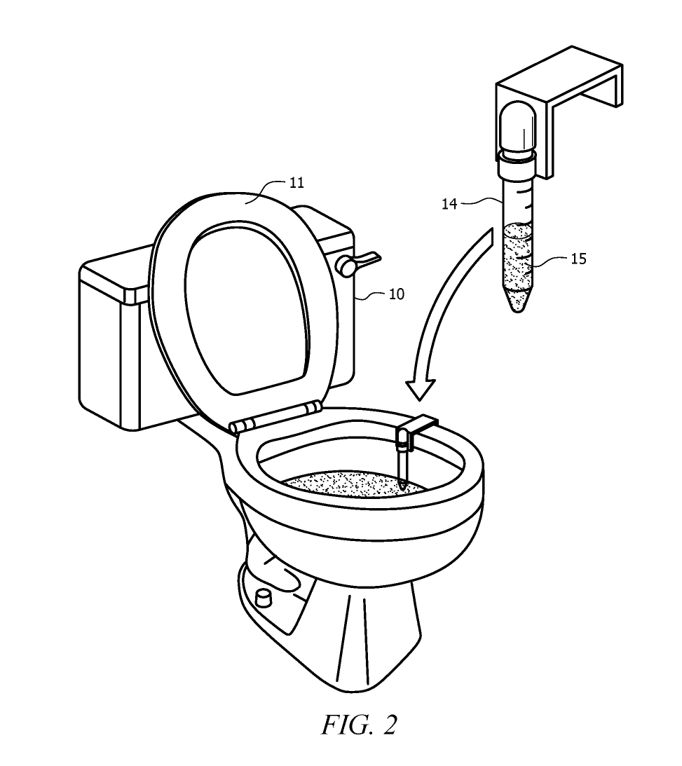

Referring to FIG. 2, a perspective view of the toilet 10 equipped with a pet deterrent 14/15 is shown. The pet deterrent 14/15 is a dispensing system 14 containing a material 15 that mixes with the water in the toilet 10, providing a non-toxic deterrent from pets 12 drinking water from the toilet 10, as the water in the toilet 10 equipped with the pet deterrent 14/15 will have a bad taste to the pet 12.

Although a metering device is shown as an example of a dispensing system 14, there is no limitation to the type of dispensing system 14 or location for such dispensing system 14. For example, in other versions of the dispensing system 14, a metering device is internal to the tank of the toilet 10 or integrated into plumbing that fills the tank of the toilet 10 with water after flushing. As another example, the material 15 is integrated into a slow-release tablet that is dropped into the tank or hung on a side of the tank of the toilet 10, thereby slowly releasing the material 15 into the water within the tank of the toilet 10. When the toilet 10 is flushed, the now foul-tasting water transfers to the bowl of the toilet 10, preventing the pet 12 from drinking the water from the bowl of the toilet 10.

The material includes a bitterant that pets 12 do not like. One anticipated bitterant is denatonium benzoate, which is known to be of a bad taste to pets 12.

When the dispensing system 14 is a metering device, a higher concentration of bitterant (e.g. denatonium benzoate) is anticipated as the metering device is capable of delivering small, measured amounts of the bitterant into the water (in the tank, bowl, or plumbing of the toilet 10). In such, it is anticipated that the material 15 comprise anywhere from 0.05% to 100.0% of bitterant (e.g. denatonium benzoate) mixed with from 0% to 99.95% of a binder such as water.

When the dispensing system 14 is a slow-release tablet that is dropped into the tank or hung on a side of the tank of the toilet 10, the slow-release tablet includes a binder of 10% to 90% fatty alcohols, 10% to 90% of a stabilizer such as aluminum hydroxide, 0% to 10% water, 0.1% to 16% of a second stabilizer such as boric acid and from 0.05% to 5% of the bitterant (e.g. denatonium benzoate), though in one embodiment, the slow-release tablet comprises approximately 0.4% of the bitterant (e.g. 0.4% denatonium benzoate).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A pet deterrent comprising:
a dispensing system containing a bitterant, the dispensing system interfaced to a toilet, thereby delivering a portion of the bitterant to water within the toilet for making drinking of the water undesirable by a pet that has access to the water within the toilet.

2. The pet deterrent of claim 1, wherein the dispensing system comprises a metering device containing the bitterant, the metering device dispensing a portion of the bitterant each time the toilet is flushed.

3. The pet deterrent of claim 2, wherein the bitterant comprises denatonium benzoate.

4. The pet deterrent of claim 1, wherein the dispensing system comprises a slow release tablet that comprises the bitterant, the slow release tablet being positioned within the toilet and interfacing with the water within the toilet, thereby releasing the bitterant into the water within the toilet.

5. The pet deterrent of claim 4, wherein the slow release tablet comprises:
from 10-90% of a binder;
from 10-90% of a stabilizer;
from 0-10% of water;
from 0.05% to 5% of the bitterant; and
from 0.1% to 16% of a second stabilizer.

6. The pet deterrent of claim 5, wherein the bitterant is denatonium benzoate.

7. The pet deterrent of claim 6, wherein the bitterant is 0.4% denatonium benzoate.

8. The pet deterrent of claim 5, wherein the binder is a fatty alcohol.

9. The pet deterrent of claim 5, wherein the stabilizer is aluminum hydroxide.

10. The pet deterrent of claim 5, wherein the second stabilizer is boric acid.

11. A pet deterrent comprising:
a slow release tablet containing a bitterant, the slow release tablet positioned within a toilet and interfaced to water within the toilet, thereby releasing a portion of the bitterant to water within the toilet for making drinking of the water undesirable by a pet that has access to the water within the toilet.

12. The pet deterrent of claim 11, wherein the slow release tablet comprises:
from 10-90% of a binder;
from 10-90% of a stabilizer;
from 0-10% of water;
from 0.05% to 5% of the bitterant; and
from 0.1% to 16% of a second stabilizer.

13. The pet deterrent of claim 12, wherein the bitterant is denatonium benzoate.

14. The pet deterrent of claim 13, wherein the bitterant is 0.4% denatonium benzoate.

15. The pet deterrent of claim 12, wherein the binder is a fatty alcohol.

16. The pet deterrent of claim 12, wherein the stabilizer is aluminum hydroxide.

17. The pet deterrent of claim 12, wherein the second stabilizer is boric acid.

18. A pet deterrent comprising:
a slow release tablet for positioning within a toilet and interfaced to water within the toilet, thereby releasing a portion of the bitterant to water within the toilet for making drinking of the water undesirable by a pet that has access to the water within the toilet;
the slow release tablet comprising:
from 10-90% of a binder;
from 10-90% of a stabilizer;
from 0-10% of water;
from 0.05% to 5% of the bitterant; and
from 0.1% to 16% of a second stabilizer.

19. The pet deterrent of claim 18, wherein the bitterant is denatonium benzoate, the binder is a fatty alcohol, the stabilizer is aluminum hydroxide, and the second stabilizer is boric acid.

20. The pet deterrent of claim 19, wherein the bitterant is 0.4% denatonium benzoate.
